(19) United States
(12) Patent Application Publication
(10) Pub. No.: US 2003/0178259 A1
(43) Pub. Date: Sep. 25, 2003

(54) Goods lift mechanism

(76) Inventor: Russell Peter Henderson, Rangiora (NZ)

Correspondence Address: Chester E. Flavin, Ross, Ross & Flavin, 120 Maple Street, Springfield, MA, 01103, US

(21) Appl. No.: 10/105,669

(22) Filed: Mar. 25, 2002

(51) Int. Cl. B66B 9/04; B66B 13/02

(52) U.S. Cl. 187/275; 187/272; 187/331

(57) ABSTRACT

A goods hoist having an elevator cage with controlled access arranged to move between a lower station and an upper station by a fluid pressure operated ram associated with a hoist mechanism located at the lower station and supported adjacent the upper station; the controlled access prevents access unless the cage is located at a predetermined location via safety interlocks.

### BACKGROUND TO THE INVENTION

Goods, such as baggage carried by passengers intending to utilize aircraft is generally checked into an airline service desk and is then transported by mechanical transporters to a location where the baggage can be loaded onto an airplane. There are however many items of goods which have to be manually carried from ground level on to an air bridge or from the air bridge to the ground. These items are generally carried up a confined stairway usually on the outside of the air bridge and the person carrying the goods generally has to negotiate through a doorway from the stairway into the interior of the air bridge and vice versa. Because of the confines of the stairway and the awkwardness that results, the likelihood of personal injury is always present. It is apparent therefore that there is a necessity for an improved method of transporting the goods between an air bridge and the ground.

### PRIOR ART

Various devices for lifting goods are known. Instances of these are illustrated in U.S. Pat. No. 4,063,619 (Drews) which discloses an elevator platform located horizontally between side panels and which is raised or lowered by hydraulic rams positioned within the side panels. The platform includes ramps to assist loading and unloading

U.S. Pat. No. 4,304,518 (Carder) discloses a loading arrangement for aircraft. The device includes a fixed elevated bridge and a main elevator which can be raised from a lower level to register with the bridge. Means are provided to ensure the platform of the main elevator will align with the bridge.

U.S. Pat. No. 4,195,962 (Laskowski) discloses a platform loading system which has an elevator platform loader unit and a magazine mounted loader unit. Each loader unit has a cargo tray and cargo transfer machinery. Each cargo tray can occupy an upper or a lower position and the load to be transferred is carried by the tray when in the upper position.

U.S. Pat. No. 4,563,121 (Drews) describes a platform loading system which utilises a pivotable cargo platform which is particularly adapted for mounting on a motor truck. The platform can move between a storage position where it is held in a vertical upright position to a horizontal position which assists loading and unloading the platform. In addition to various fail safe systems, a latching system is also provided to maintain the platform in a storage position.

U.S. Pat. No. 4,087,007 discloses another form of cargo platform which is also adapted for mounting on the back of a motor truck. The platform includes a first section which is pivotally mounted to an elevating platform and a second section which is pivotally mounted to the first section. The two sections are arranged to maintain the platform sections in substantially co-planar relationship. The cargo platform can be lowered when in a vertical storage position from an upper position where it partially closes the opening to the cargo body to a lower position where ingress into and egress out of the cargo body is provided.

U.S. Pat. No. 3,749,201 discloses yet another ambulatory cargo elevator which uses a hydraulic cylinder located with a vertical mast. The platform is connected to the cylinder in a manner that the platform can be raised and lowered. Cables are provided which act between the hydraulic cylinder and the platform to enable the platform to be tied into a hold position which will narrow the width of the elevator to enable the elevator to pass through a doorway.

While all the above mechanisms are specifically designed to transport cargo and to move it between an upper and lower position and vice versa, none of the mechanism is capable of fulfilling the specialised requirements of moving goods, and in particular luggage, from the ground up to and through a door into the interior of the air bridge or vice versa.

### OBJECT OF THE INVENTION

It is therefore an object of this invention to provide a goods hoist having an elevator cage which is capable of transporting goods between a lower station and an upper station and with the elevator cage being operable from a remote location and which includes safety means to prevent access to the elevator cage unless the cage is stationary at a station.

### DISCLOSURE OF THE INVENTION

Accordingly the invention comprises a goods hoist which includes:

a hoist frame including spaced apart vertically orientated guide rails,

means to attach the lower end of each guide rails to a support

means to anchor the upper end of each guide rails to an existing structure,

an elevator cage adapted to have vertical reciprocatory movement on the guide rails of the hoist frame between a lower station and an upper station,

a perimeter frame surrounding the hoist frame at the lower station,

a door associated with the perimeter frame to enable access to the elevator cage only when the elevator cage is at the lower station,

a fluid pressure operated ram adapted to act on the elevator cage to raise or lower the elevator cage

means to control the operation of the fluid pressure operated ram,

means to provide an interlock to prevent access to the elevator cage until it has stopped at a predetermined position and

means to initiate movement of the elevator cage only when the door associated with the perimeter frame is closed and any other ancillary safety features are in a safe condition.

Preferably the means to anchor the upper end of the guide rails to a supporting structure comprises a stability frame joined to the guide rails at a location remote from the lower station and attached to the supporting structure.

Preferably the fluid pressure operated ram is a three stage ram.

Preferably the fluid pressure operated ram is a hydraulic ram.

A goods hoist for moving goods between a lower station and at least one upper station, said hoist including an elevator cage arranged to move between the lower station and an upper station

a fluid pressure operated ram acting on the elevator cage to move the frame between the stations,

spaced apart vertical guide rails which guide the elevator cage during its movement between stations.

stability braces adapted to connect the guide rails and to tie the guide rails to an existing structure to maintain the guide rails in a substantially vertical orientation,

a perimeter frame which surrounds the elevator cage when the elevator cage is at the lower station,

a door associated with the perimeter frame to enable access to the elevator cage when the elevator cage is stationary at the lower station,

a door associated with each upper station to provide access to the elevator cage only when the elevator cage is stationary at the upper station and

interlocking door means to prevent opening of the door associated with each upper station and the door associated with the perimeter frame unless the elevator cage is at rest at the station,

means located at each station to control, in conjunction with the interlocking door means, the movement of the elevator cage between the upper station and the lower station.

### BRIEF DESCRIPTION OF THE DRAWINGS

Preferred forms of the invention will now be described with the aid of the accompanying drawings wherein:

FIG. 1 is a view of the hoist illustrating the perimeter frame surrounding the elevator cage which is in the lowered position.

FIG. 2 is a diagrammatic illustration of the structure from the rear.

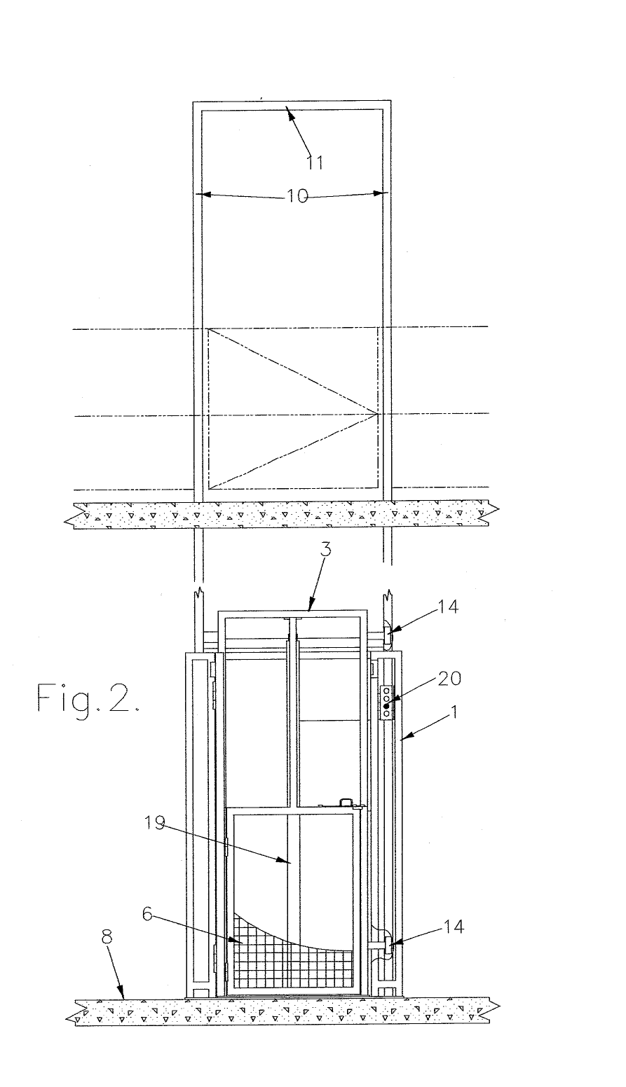

FIG. 3 is a view of the structure attached to a building with the elevator cage at an intermediate position.

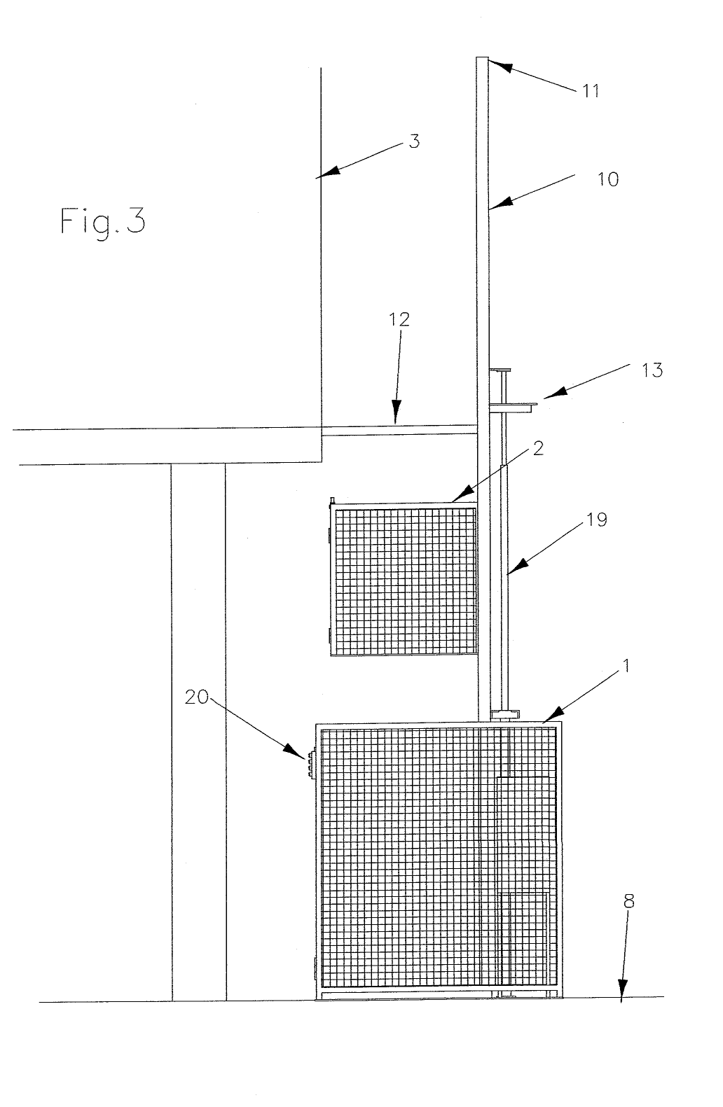

FIG. 4 is a view of the loading/discharge end of the elevator cage in its lowered position and with the access door open.

### DETAILED DESCRIPTION OF THE PREFERRED FORMS OF THE INVENTION

As illustrated, the structure includes a perimeter frame 1, an elevator cage 2, a hoist frame 3 and a hoist mechanism. The perimeter frame 1 is of a size that it will totally enclose the elevator cage 2 on all sides with the frame being generally rectangular in shape and of an appropriate height which is preferably, but not necessarily approximately two meters although the height can be varied as desired. The perimeter frame is preferably formed of hollow section rectangular tubing which is corrosion proofed as it is known in the art. The perimeter frame 1 is covered or infilled with a suitable mesh screen 6.

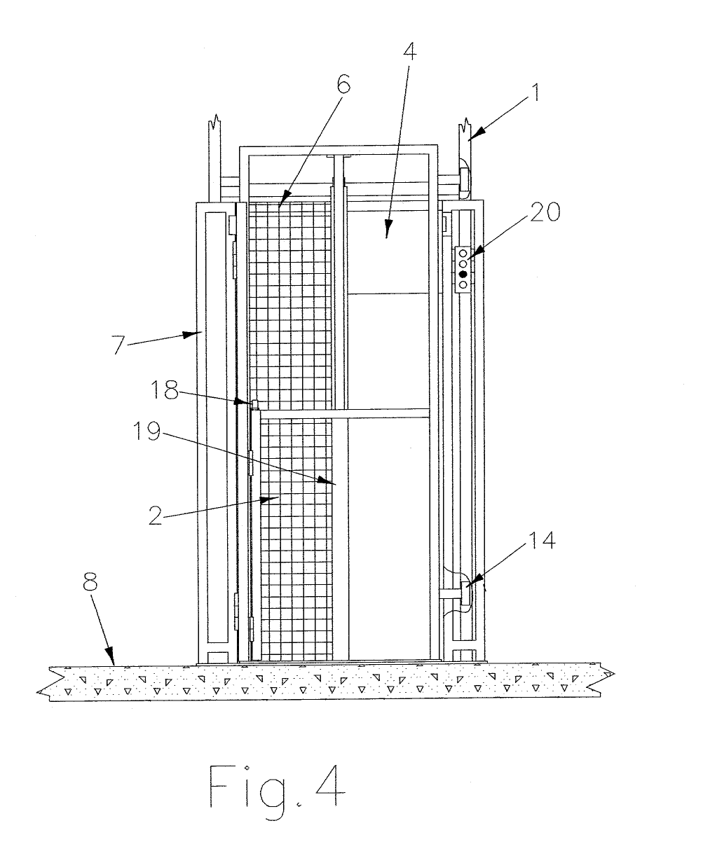

The perimeter frame 1 also includes a door 7 to enable access to the interior of the perimeter frame. The door 7 is swung from one of the side posts of the frame 1 so it can be opened to provide access to the loading/discharge end of the elevator cage (see particularly FIG. 4). Suitable locking arrangements for the door are provided as will be herein further described.

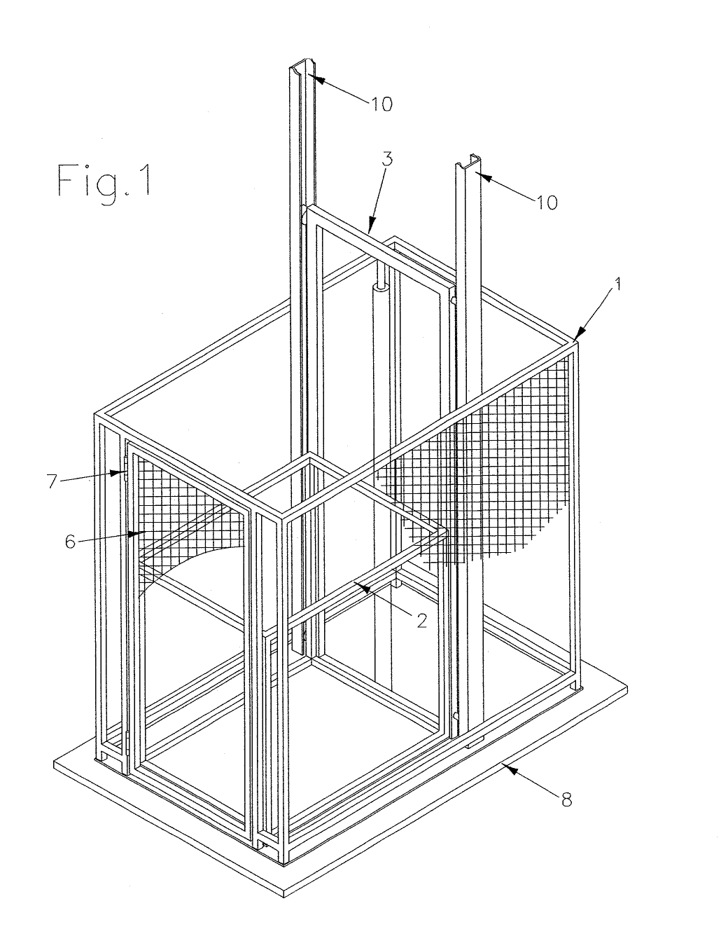

As illustrated particularly in FIG. 1, the perimeter frame 1 is adapted to be anchored to a concrete pad 8 or similar support.

The hoist mechanism includes two spaced apart vertically orientated guide rails 10 having their lower ends firmly anchored to the concrete slab 8 or to some other suitable support. The guide rails 10 extend upwardly and joined at or adjacent their upper ends by a cross member 11.

A stability frame which may be composed of braces 12 is provided to tie the upper portion of the guide rails 10 to an existing structure, such as the side of or a platform provided on an air bridge or to the outside wall of a passenger terminal 3 with access internally. It will be understood that the stability braces are attached to the structure of the air bridge or passenger terminal at the location preferably of an existing door which provides access to the interior of the air bridge or passenger terminal. The door and its surrounds are modified to enable it to be operated in conjunction with the goods hoist. In use, the ground frame is fixed at the desired location and the free ends of the stability braces are fixed to the existing structure thereby providing a semi-permanent installation. A guide rail brace 13 is also preferably provided at about the point of junction of the stability braces 12 with the guide rails 10 for additional stability.

The elevator cage 2 is supported by the hoist frame 3 which includes guide wheels 14 or rollers attached to the hoist frame 3 in a manner that the wheels will run in tracks 15 formed in the guide rails 10 so that the up and down movement of the hoist frame 13 will be constrained by the guide wheels 14. The elevator cage 2 and the hoist frame 3 are typically manufactured from metal tubing to form rigid structures. The sides of the elevator cage 2 and the rear of the cage, that is the part of the cage nearest the guide rails 10, may be infilled with a mesh screen 6. The front of the elevator cage is provided with a door 18 to enable access to the interior of the case.

The raising and lowering of the hoist frame 3 with the elevator cage 2 is preferably obtained by means of a fluid pressure operated ram 19 which is located between the guide rails 10 and which has its lower end anchored to the pad 8 and the upper end anchored to the hoist frame 3. The ram is operated by a suitable fluid pressure pump (not shown in the drawings) which may be driven by an electric motor operated through control means. Preferably, but not necessarily, the fluid pressure operated ram is at least a three stage operation to ensure adequate speed in operation. In a highly preferable form, the fluid pressure operated ram is arranged so that the time to fully raise or lower the elevator cage is no more than fifteen seconds. Preferably also the mechanism operating the fluid pressure operated ram is fitted with a suitable timer switch so that if the hoist is not used within a predetermined time limit, the ram will be automatically operated to return the elevator cage to its lower, rest position. This operation will assist in preventing corrosion of the units. The timer switch is preferably variable to allow for appropriate adjustment of the automatic return phase. In a highly preferred form the fluid pressure operated ram is a hydraulic ram.

As illustrated, particularly in FIG. 4, in its rest position, the elevator cage is held above the ground, preferably by up to 500 mm to facilitate loading and unloading. FIG. 4 also illustrates the door 7 to the perimeter frame and the door 18 to the elevator cage in an open condition.

The operation of the hoist is preferably controlled by suitable electronically controlled interlock switches and may consist of a call and send electronic system which is operated by control panels 20, such as that illustrated in FIG. 4. A control panel will generally be situated at the ground level and at each upper level if there is more than one upper level. The control panel can typically consist of up, down and emergency stop buttons.

In addition the system includes inbuilt safety features to prevent operation of the hoist, unless all the safety gates are locked. Preferably also the opening and closing of the door 7 is both manually and electronically locked to enable access to the interior of the perimeter frame 1 only when the elevator cage is stationery in the required location.

To install the hoist, a suitable concrete slab 8 or other appropriate foundation is provided and the guide rails 10, the perimeter frame 1 and the fluid pressure operated ram 19 are all anchored to the slab 8. The stability braces 12 are attached to the structure of the air bridge and the usual door to the air bridge is altered so the door can be opened only when the elevator cage is at the appropriate level. The electronic control panel is installed and appropriately wired to the hoist. The power pack to supply fluid to the hydraulic ram is anchored within the perimeter frame and is piped to the fluid pressure operated ram with delivery of fluid being controlled by the electronic controls. Preferably the fluid pressure operated ram also includes a manual dump valve.

Having disclosed preferred forms of putting the invention into effect, it will be apparent to those skilled in the art that modifications and amendments can be made to the various structures and yet still come within the basic concept of the invention. All such modifications and amendments are intended to be included within the scope of this invention.

1. A goods hoist which includes:
a hoist frame including spaced apart vertically orientated guide rails,
means to attach the lower end of each guide rails to a support
means to anchor the upper end of each guide rails to an existing structure,
an elevator cage adapted to have vertical reciprocatory movement on the guide rails of the hoist frame between a lower station and an upper station,
a perimeter frame surrounding the hoist frame at the lower station,
a door associated with the perimeter frame to enable access to the elevator cage only when the elevator cage is at the lower station,
a fluid pressure operated ram adapted to act on the elevator cage to raise or lower the elevator cage
means to control the operation of the fluid pressure operated ram,
means to provide an interlock to prevent access to the elevator cage until it has stopped at a predetermined position and
means to initiate movement of the elevator cage only when the door associated with the perimeter frame is closed and any other ancillary safety features are in a safe condition.

2. The goods hoist as claimed in claim 1, wherein the means to anchor the upper end of the guide rails to a supporting structure comprises a stability frame joined to the guide rails at a location remote from the lower station and attached to the supporting structure.

3. The goods hoist of claim 1, wherein the fluid pressure operated ram is a three stage ram.

4. The goods hoist of claim 3, wherein the fluid pressure operated ram is a hydraulic ram.

5. A goods hoist for moving goods between a lower station and at least one upper station, said hoist including an elevator cage arranged to move between the lower station and an upper station
a fluid pressure operated ram acting on the elevator cage to move the frame between the stations,
spaced apart vertical guide rails which guide the elevator cage during its movement between stations,
stability braces adapted to connect the guide rails and to tie the guide rails to an existing structure to maintain the guide rails in a substantially vertical orientation,
a perimeter frame which surrounds the elevator cage when the elevator cage is at the lower station,
a door associated with the perimeter frame to enable access to the elevator cage when the elevator cage is stationary at the lower station,
a door associated with each upper station to provide access to the elevator cage only when the elevator cage is stationary at the upper station and
interlocking door means to prevent opening of the door associated with each upper station and the door associated with the perimeter frame unless the elevator cage is at rest at the station,
means located at each station to control, in conjunction with the interlocking door means, the movement of the elevator cage between the upper station and the lower station.
